(19) United States
(12) Patent Application Publication
(10) Pub. No.: US 2004/0080178 A1
(43) Pub. Date: Apr. 29, 2004

(54) Folding roof for a convertible vehicle

(76) Inventors: Berthold Klein, Rutesheim (DE); Klaus Laue, Sindelfingen (DE); Wojciech Wezyk, Sindelfingen (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/660,100

(22) Filed: Sep. 11, 2003

(30) Foreign Application Priority Data
Sep. 12, 2002 (DE) 102 42 501.9

(51) Int. Cl. B60J 7/20

(52) U.S. Cl. 296/107.08

(57) ABSTRACT

In a roof for a convertible vehicle including a folding roof supported by a linkage mounted to the vehicle body with a roof cover material extending over the linkage wherein the folding roof is movable between a closed position, in which it covers an interior vehicle space, and a storage position, in which it is deposited in a folding roof storage space, a rigid rear roof part is provided, which is supported by the vehicle body in a closed position when the folding roof is in a closed position and also when the folding roof is stored in the roof storage space.

### BACKGROUND OF THE INVENTION

The invention relates to a folding roof for a convertible vehicle which includes a roof linkage mounted to the vehicle body with a roof cover material supported on the roof linkage, the folding roof being movable between a closed position, in which it covers an interior vehicle space and an open position, in which it is disposed in a storage space.

DE 197 13 710 A1 discloses such a folding vehicle roof with a roof cover material and a roof linkage. The linkage comprises a plurality of linkage members, which extend in the longitudinal and transverse directions and which are kinematically movably interconnected or, respectively, coupled to the vehicle body. With a hydraulic operating member, the vehicle roof is movable between a closed position in which it covers the interior space of the vehicle and a storage position in a storage compartment behind the vehicle interior. The storage compartment is covered by a pivotally supported storage compartment lid, which can be raised for the transfer of the vehicle folding roof into the storage compartment or for the removal of the folding roof from the storage compartment.

When the vehicle roof is in the storage position, the vehicle is in a cabriolet configuration. No other roof opening positions are provided for the vehicle roof.

It is the object of the present invention to provide a folding roof for a vehicle, which can also be converted to a Targa configuration, that is, a configuration in which the rear roof part remains in place.

### SUMAMRY OF THE INVENTION

In a roof for a convertible vehicle including a folding roof supported by a linkage mounted to the vehicle body with a roof cover material extending over the linkage wherein the folding roof is movable between a closed position, in which it covers an interior vehicle space, and a storage position, in which it is deposited in a folding roof storage space, a rigid rear roof part is provided which is supported by the vehicle body in a closed position when the folding roof is in a closed position and also when it is stored in the roof storage space.

The vehicle roof according to the invention comprises a rear vehicle roof part, which is rigid and which has a rear window panel integrated therein and which is in a closed position in the closed or in the open position of the vehicle roof. The rear roof part extends above the vehicle body line and is level with the vehicle roof line when the vehicle roof is closed. In this way, the vehicle is in a Targa configuration when the roof is open. In this configuration, the removable folding roof is deposited in the roof storage compartment whereas the rear roof part remains in its position, which it has when the folding roof part is closed.

In contrast to the state-of-the-art designs wherein, for the realization of a Targa configuration, an upper rigid roof part has to be either manually removed or deposited in a location below a rear rigid roof part, by using a folding roof, a relatively long area of the vehicle interior can be opened while, at the same time, the rear roof part can remain in position so as to realize a Targa configuration of the vehicle. This provides for an open-roof arrangement of the vehicle, which has for the advantages of a Cabriolet configuration—a sidewardly wide open vehicle interior—and the advantages of the Targa configuration—good wind protection and high rollover safety, particularly if a rollover bar is incorporated into the roof part, which extends above the rear window. No further rollover safety arrangements are then needed.

The folding roof is preferably supported on the vehicle body by a suitable operating mechanism, which may include a multi-link operating mechanism or a simple pivot joint. If a multi-link operating mechanism is used, expediently, two pivotally interconnected arms may be used which extend transverse to the longitudinal vehicle direction when the folding roof is deposited in the storage compartment The lower arm is pivotally connected to the vehicle body and the upper arm is pivotally connected to the folding roof. Upon transfer from the closed and the storage position, the two arms are pivoted into a orientation transverse to the longitudinal vehicle axis whereby a very compact storage arrangement can be achieved. The connection of the upper arm to the folding roof follows during movement into the storage compartment expediently only a vertical path, possibly combined with a movement in the longitudinal vehicle direction, but there is no transverse component of movement. This can be achieved by providing two arms of the same length so that the arms can be folded together in a scissor-like manner without requiring any transverse movement of the connecting point of the upper arm to the folding roof.

The operating mechanism, by which the folding roof is coupled to the vehicle body, is expediently supported at the bottom of the storage compartment which provides for a compact arrangement.

The folding roof and the roof support linkage with the roof cover material may also be deposited in the storage compartment vertically or almost vertically so that, in the longitudinal vehicle direction, the storage space requirements are minimal. However, the folding roof may also be deposited horizontally or in an inclined position.

The invention will be described below in greater detail on the basis of the accompanying drawings.

### BRIEF DESCRIPTION OF THE DRAWINGS

FIG. 1 is a side view of a convertible vehicle with a removable vehicle roof shown in a closed position, wherein the vehicle roof comprises a folding roof and a rigid rear roof part.

FIG. 2 is an enlarged view of the vehicle roof in a closed position.

FIG. 3 shows the folding roof section in an intermediate position during the transfer from the closed to the storage position with partially raised rear roof part,

FIG. 4 shows the folding roof in a further advanced intermediate position with the rear roof section raised to the maximum extent,

FIG. 5 shows the folding roof in a vertical storage position wherein the rear roof part is again approaching its closed position,

FIG. 6 shows the vehicle roof in a Targa configuration with the front roof being deposited vertically in the storage compartment and the rear roof part being closed,

FIG. 7 is a cross-sectional view of the vehicle roof in the longitudinal direction in the transition area between the rear roof part and the folding roof,

FIG. 8 is a side view showing a rollover bar and a locking structure for the rear roof part,

FIG. 9 shows a modified embodiment of the removable vehicle roof in an intermediate position during the transfer from the closed to the storage position, wherein the rear roof part is raised at its front end,

FIG. 10 shows the folding roof deposited in the rear storage space with the rear roof part raised,

FIG. 11 shows the rear roof part raised at its rear end to permit loading and unloading of the trunk,

FIG. 12 shows the vehicle roof in a Targa configuration wherein the front folding roof is in its storage position and the rear roof part is closed, and

FIG. 13 shows an operating mechanism for the folding roof including sidewardly foldable arms of the multi-link operating mechanism by which the roof is supported on the vehicle body.

### DESCRIPTION OF PREFERRED EMBODIMENTS

In the figures, identical components are designated by the same reference numerals.

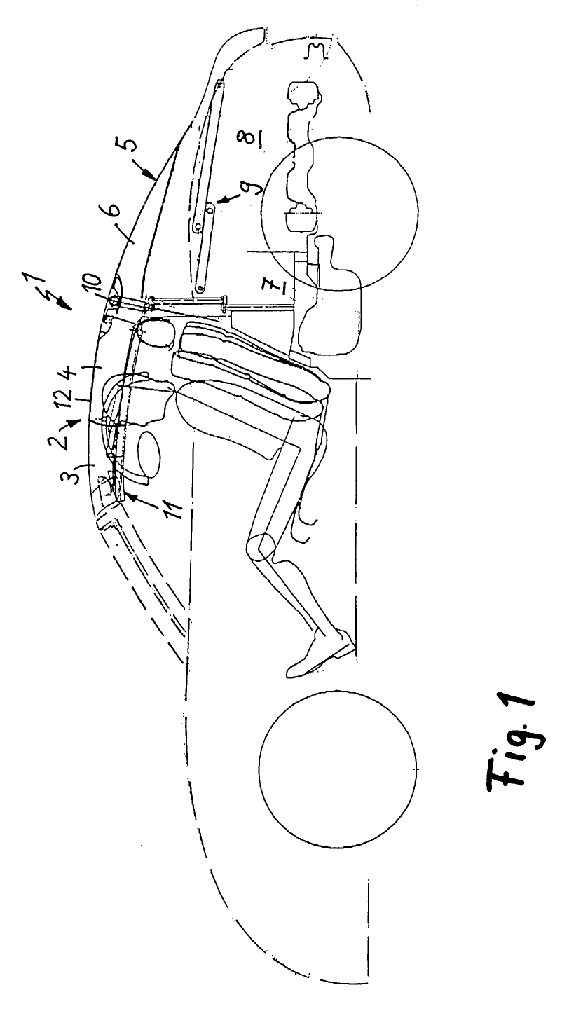

The convertible vehicle shown in FIG. 1 comprises a removable vehicle roof, which is shown in FIG. 1 in a closed position, in which it cover the interior space of the vehicle and which can be transferred to a storage position, in which the vehicle interior is open. The vehicle roof 1 includes a folding roof 2 with a front folding roof section 3 and a rear folding roof section 4 and a rear rigid roof part 5, which is disposed adjacent the rear folding roof section 4. The folding roof 2 comprises a roof support linkage 11 with a plurality of longitudinal and transverse frame members and a roof cover material 12, which is supported by the support linkage 11 and which extends over the front folding roof section 3 and the rear folding roof section 4 when the vehicle roof is closed. The frame members of the support linkage 11 are partially part of the front and partially part of the rear folding roof sections 3 and 4.

The rear roof part 5 has a rear window panel 6 incorporated therein. The rear roof part 5 forms at the same time a trunk lid, which extends up to the rear end of the vehicle. The roof part 5 is pivotally supported on the vehicle body and covers in its closed position a roof storage compartment 7 for the reception of the folding roof 2 as well as a trunk 8 arranged behind the storage compartment 7 so that the rear roof part 5 forms a lid for the folding roof storage compartment 7 and for the trunk 8.

In the upper front area of the rear roof part 5, adjacent the folding roof 2, there is, adjacent the rear window 6, a rollover bar 10 arranged so as to extend in a transverse direction for the protection of the occupants. The rear roof part 5 can be raised from the rear end by an operating linkage 9 for loading or unloading the trunk 8 or at its front end for the transfer of the folding roof 2 between its closed and its storage positions. The rear end of the roof part 5 can be raised independently of the position of the folding roof 2.

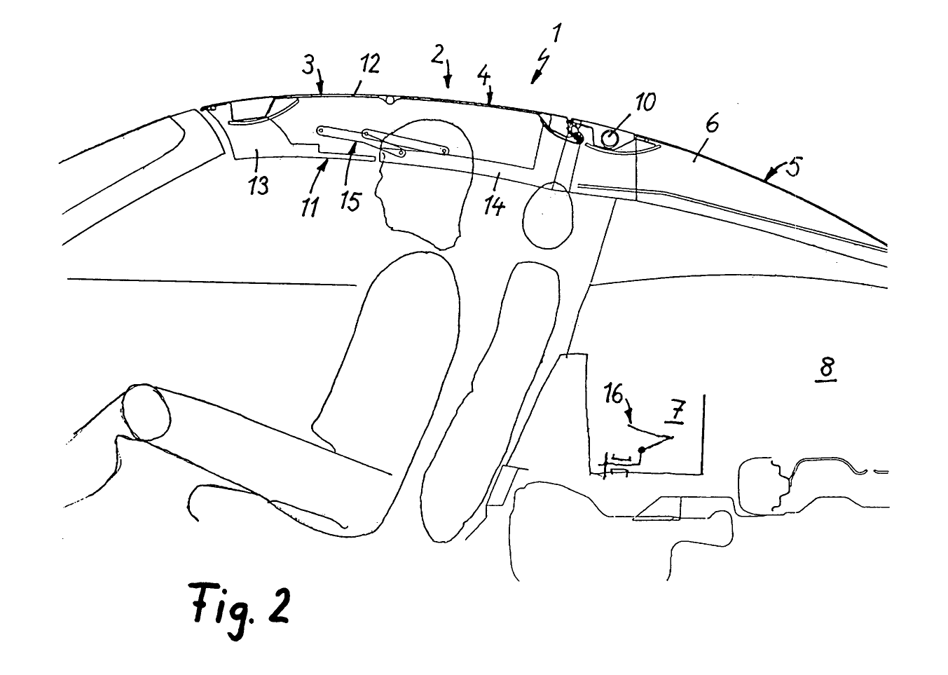

As apparent from the enlarged representation of FIG. 2, the front folding roof section 3 includes a longitudinal frame member 13 and the rear folding roof section 4 includes a longitudinal frame member 14. Both longitudinal frame members 13 and 14 extend in the longitudinal vehicle direction when the roof is closed. The longitudinal frame members 13 and 14 are interconnected by an operating linkage 15, which, in the embodiment shown, is a four-link mechanism. The rear folding roof section 4 is mounted to the vehicle body by an operating mechanism 16, which is shown only schematically and on a reduced scale and which is mounted to the bottom of the vehicle roof storage compartment 7.

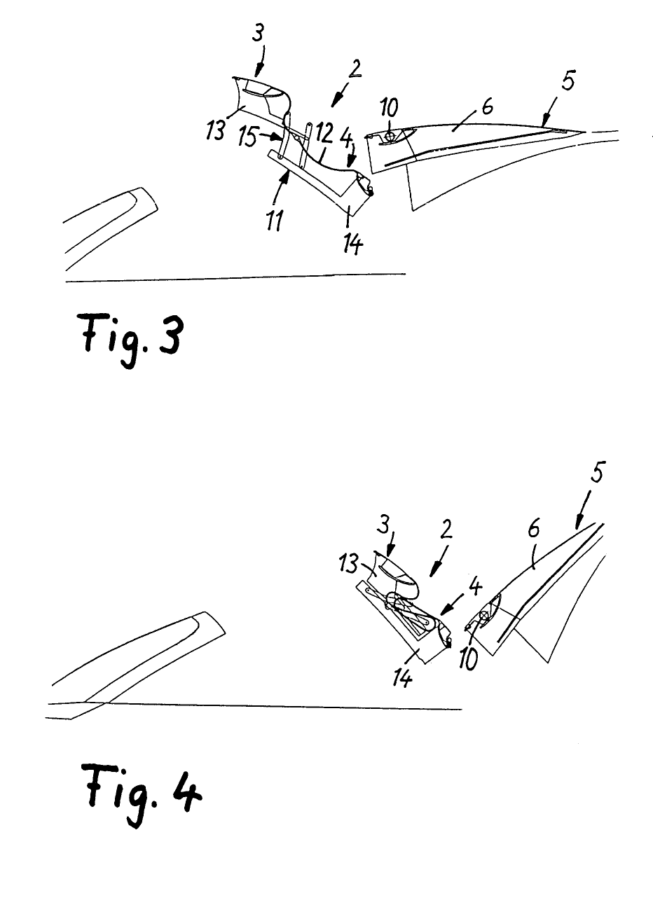

FIG. 3 shows the folding roof 2, shortly after its release from the closed position, in an intermediate position during its transfer to the storage position. The front folding roof section 3 is pivoted by the operating mechanism 15 into a raised position with respect to the rear folding roof section 4. At the same time, the complete folding roof 2 is moved backwardly toward the storage position. The rear roof part 5 with the rear window panel 6 is raised at its rear end and, at the same time, moved backward toward the rear end of the vehicle. This movement is expediently accomplished by a four-link operating mechanism.

FIG. 4 shows the folding roof 2 in a further advanced intermediate position during the transfer to the storage compartment. The front folding roof section 3 is now in a position fully above the rear folding roof section 4. The rear roof part 5 is in its maximum open position with the rear end thereof raised.

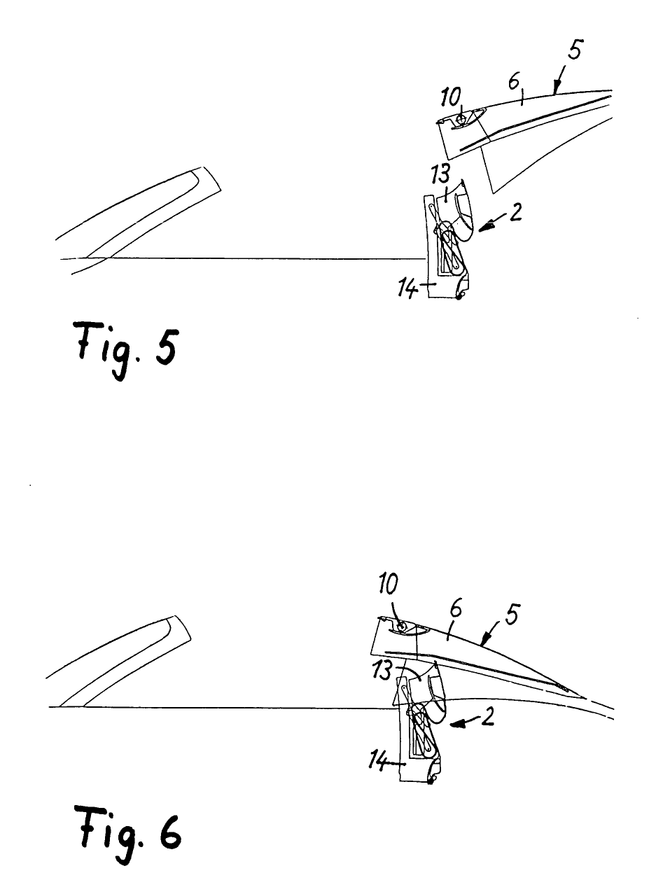

FIG. 5 shows the folding roof 2 in its storage position wherein the folding roof 2 is deposited in the storage compartment in a vertical orientation. The vertical storage orientation requires only a relatively small space in the longitudinal vehicle direction. The rear roof part 5 is shown in an intermediate position between its fully open and the closed positions.

FIG. 6 shows the rear roof part 5 again in the closed position in which the storage compartment with the folding roof 2 contained therein is covered. In this position of the folding roof 2, the vehicle is in a Targa configuration.

As shown in FIG. 7, a sealing arrangement 17 is provided between the rear folding roof section 4 of the folding roof 2 and the rear rigid roof part 5 which, when the folding roof 2 is closed, provides for a wind and water tight connection between the folding roof 2 and the rear roof part 5.

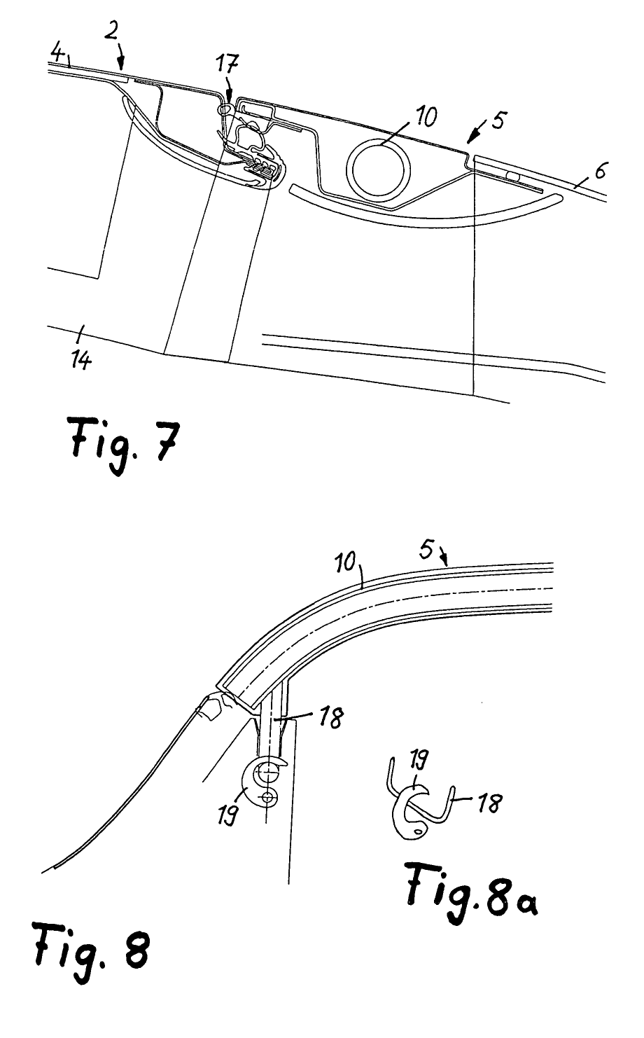

FIG. 8 shows that clamping yoke 18 is connected to the rollover bar 10 at the underside thereof which, in the closed position of the rear roof part, is engaged by a vehicle body-mounted clamping hook 19 and is locked thereby in position. The clamping yoke 18 is U-shaped as shown in the perspective representation of FIG. 8a.

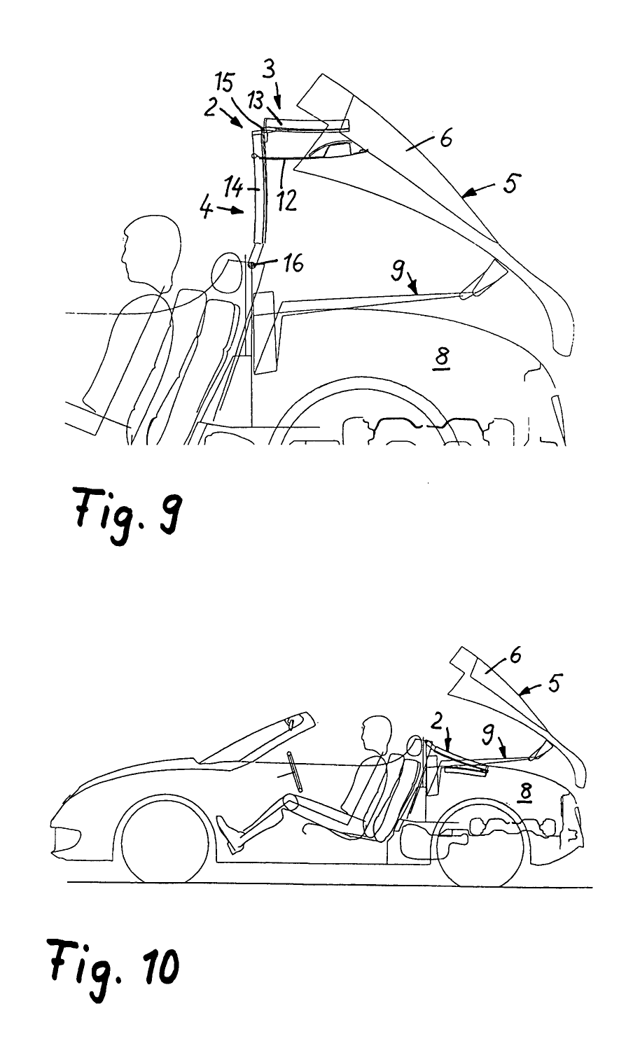

FIGS. 9-12 show another embodiment of the vehicle roof with a two-section folding roof 2 and a rear rigid roof part 5. In this embodiment, the operating mechanism 16, by way of which the folding roof 2 is supported on the vehicle body, is a simple pivot joint. Also, the relative motion linkage interconnecting the front folding roof section 3 and the rear folding roof section 4 is in the form of a simple pivot joint, which permits a relative movement of the front folding roof section 3 with respect to the rear folding roof section 4 into the roof storage position.

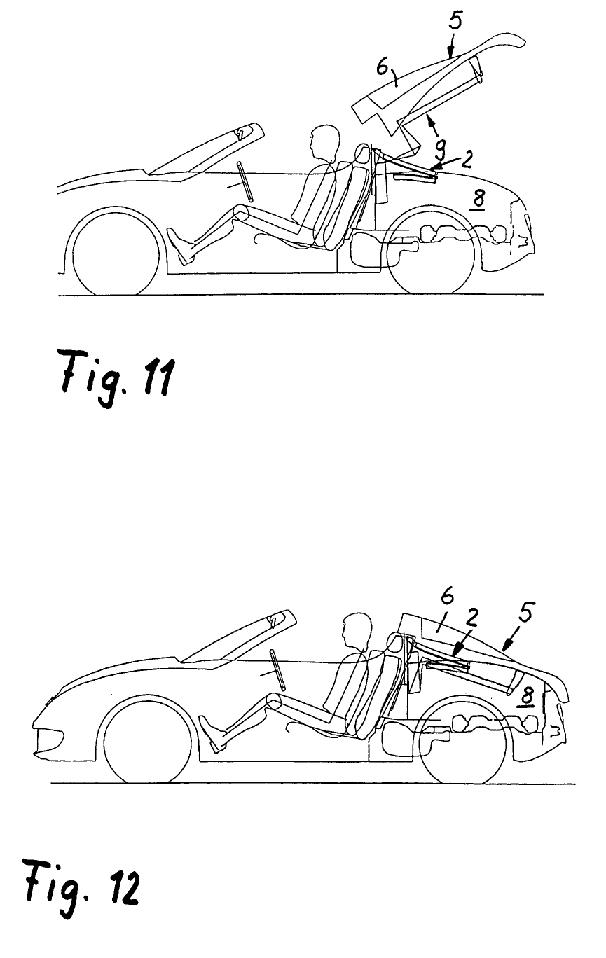

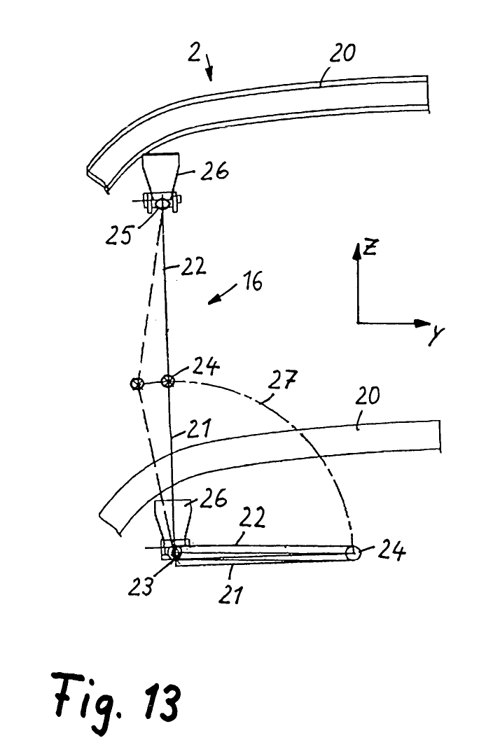

The operating mechanism 9, by way of which the rear rigid roof part 5 can be raised, permits raising of the front end of the rear part—this is shown in FIGS. 9 and 10 and is part of the transfer movement of the folding roof 2 between the closed and the storage positions thereof—as well as raising of the rear end of the rear roof part 5—this is shown in FIG. 11 and is utilized for the loading and unloading of the trunk 8 independently of the position of the folding roof 2. FIG. 12 shows the roof in a Targa configuration wherein the folding roof 2 is in the storage compartment and the rear roof part 5 is closed. The folding roof 2 is disposed in the storage compartment or in the trunk 8 in an essentially horizontal position. FIG. 13 shows in detail the operating mechanism 16 by which the folding roof 2, particularly a transverse frame member 20 of the folding roof 2, is movably supported on the vehicle body and the folding roof 2 is transferable between the closed and the storage positions. The operating mechanism comprises a lower operating arm 21 and an upper operating arm 22, wherein the lower operating arm 21 is pivotally connected to the vehicle body by means of a pivot joint 23 so as to permit transverse pivoting of the arm 21. The upper operating arm 22 is pivotally connected to the lower operating arm 21 by another pivot joint 24. At its end opposite the lower operating arm 21, the upper operating arm 22 is pivotally connected by still another pivot joint 25 to a yoke 26 which is firmly mounted to the transverse frame member 20. All three pivot joints 23, 24 and 25 of the operating mechanism 16 permit pivot movements about pivot axes, which extend parallel to the longitudinal vehicle axis.

For the transfer of the folding roof 2 from the (raised) closed position to the storage position (lowered position), the operating mechanism 16 is actuated by a suitable operating member, for example, a hydraulic cylinder such that the two operating arms 21 and 22 are pivoted out of the stretched positions along the annular line 27 into a transverse storage position in which both operating arms 21 and 22 extend transverse to the longitudinal vehicle direction and are disposed directly on top of one another. The pivot joint interconnecting the two operating arms 21 and 22 is then moved inwardly. The two operating arms 21 and 22 have the same length so that the folding roof 2 is merely lowered in the z-direction, but is not moved in the y-direction. Because of the movement of the operating arms 21 and 22 in a plane transverse to the longitudinal vehicle direction, the required storage volume for the operating mechanism 16 is minimal.

When the roof is closed (raised position), it may be expedient to leave the operating arms 21 and 22 in the over-dead-center position as indicated by the dashed lines in order to prevent an unintentional collapse of the operating mechanism 16.

For symmetry, an operating mechanism 16 is provided at each of the two sides of the roof so that the vehicle roof is evenly supported and moved between the closed and the storage positions.

The operating mechanism 16 as shown is not only applicable to folding roofs with a roof cover material, but also to hardtop roofs with rigid roof parts. In that case, the components designated by the reference numeral 20 would be such a rigid roof part of a hardtop vehicle roof.

What is claimed is:

1. A roof for a convertible vehicle having a vehicle body and including a folding roof (2) supported by a linkage (11) mounted to the vehicle body with a roof cover material (12) extending over said roof linkage (11), said folding roof (2) being movable between a closed position in which it covers an interior vehicle space and a storage position in which it is deposited in a folding roof storage space (7), and a rigid rear roof part (5) supported by said vehicle body but being in a closed position when the folding roof (2) is in a closed position and also when folding roof (2) is in a storage position.

2. A vehicle roof according to claim 1, wherein said rear roof part (5) is movably supported on said vehicle body.

3. A vehicle roof according to claim 2, wherein said vehicle body includes a folding roof storage compartment (7) in which the folding roof (2) is deposited for storage and said rear roof part (5) extends over said storage compartment (7).

4. A vehicle roof according to claim 3, wherein said rear roof part (5) extends also over the vehicle trunk (8).

5. A vehicle roof according to claim 1, wherein said folding roof (2) comprises a front folding roof section (3) and a rear folding roof section (4) and each folding roof section (3, 4) includes a longitudinal frame member (13, 14) which, in the closed position of the folding roof (2), extend in the longitudinal direction of the vehicle and wherein a longitudinal frame member (13) of the front folding roof section (3) is pivotally connected to the respective longitudinal frame member (14) of the rear folding roof section (4).

6. A vehicle roof according to claim 5, wherein the longitudinal frame member (13) of the front folding roof section (3) is coupled to the longitudinal frame member (14) of the rear folding roof section (4).

7. A vehicle roof according to claim 5, wherein said longitudinal frame member (13) of the front folding roof section (3) is connected to the longitudinal frame member (14) of said rear roof section (4) by a pivot joint.

8. A vehicle roof according to claim 1, wherein said folding roof (2) is connected to the vehicle body by way of a pivot joint.

9. A vehicle roof according to claim 1, wherein said folding roof (2) is connected to the vehicle body by a multi-joint operating mechanism.

10. A vehicle roof according to claim 9, wherein said multi-joint operating mechanism comprises two operating arms (21, 22) which are pivotally joined and which extend in the storage position of the folding roof (2) in a direction transverse to the longitudinal vehicle axis.

11. A vehicle roof according to claim 10, wherein said two operating arms (21, 22) comprise lower and upper operating arms and said lower operating arm (21) is pivotally connected to the vehicle body and said upper operating arm (22) is pivotally connected to said folding roof (2).

12. A vehicle roof according to claim 11, wherein, in the closed position of the vehicle folding roof (2), said lower operating arm (21) and said upper operating arm (22) are in an over-dead-center position.

13. A vehicle roof according to claim 11, wherein said lower and said upper operating arms (21, 22) have the same length.

14. A vehicle roof according to claim 1, wherein said folding roof sections (3, 4) are deposited in the storage compartment 17 in a vertical orientation.

15. A vehicle roof according to claim 1, wherein the operating mechanism (16) for the folding roof (2) is arranged at the bottom of the storage compartment (7).

16. A vehicle roof according to claim 1, wherein said rear roof part (5) includes a rollover bar (10) which is integrated into the rear roof part (5).
